(19) United States
(12) Patent Application Publication
(10) Pub. No.: US 2015/0088365 A1
(43) Pub. Date: Mar. 26, 2015

(54) Driver utilization of real-time continuous diagnostic data for an operational vehicle

(71) Applicant: eLog Advantage, Inc., RENTON, WA (US)

(72) Inventors: Larry Cook, Renton, WA (US); M. Grant Sharp, Renton, WA (US)

(21) Appl. No.: 14/492,012

(22) Filed: Sep. 20, 2014

Related U.S. Application Data
(60) Provisional application No. 61/880,810, filed on Sep. 20, 2013.

(51) Int. Cl. G07C 5/00

(52) U.S. Cl. CPC G07C 5/008
USPC 701/31.4; 701/29.1

(57) ABSTRACT

A device that performs real-time continuous data extraction from an Engine Control Module to process the data on a portable, full-function, small-size computer in a driver's compartment of a motor vehicle. The device that formats and displays data, calculates results and distributes reports to a variety of visual display devices for viewing in the driver's compartment by an operator of a vehicle while driving.

A device that produces inspection reports for mechanics, regulators and drivers, real-time emission test results on demand and live vehicle performance reporting.

### CROSS-REFERENCE TO RELATED APPLICATIONS

This application claims benefit of U.S. provisional patent application Ser. No. N 61/880,810 filed Sep. 20, 2013, and entitled AN ENGINE DATA MANAGEMENT SYSTEM FOR VEHICLE ENGINE DIAGNOSTIC MONITORING, HISTORICAL DATA RECORDING AND REAL-TIME PERFORMANCE MANAGEMENT, the disclosure of which is incorporated herein by reference.

### BACKGROUND

This disclosure relates to utilization of real-time continuous diagnostic data for an operational vehicle by a driver to increase vehicle performance and efficiency, to improve driving patterns and comply with various federal, state and local regulations governing operation of a vehicle on public highways.

Safe operation of a motor vehicle is a concern for manufacturers, highway safety officials, all motorists at large and especially vehicle operators. The same beneficiary groups are also concerned with efficient operation of motor vehicles. Diagnostic data extracted from the vehicle engine computer, or Engine Control Module (ECM), can be utilized to alleviate the concerns of the stakeholders in all categories related to the operation of private and commercial vehicles.

### SUMMARY

In accordance with this disclosure, an automated system performs real-time (live) continuous extraction of the ECM data while a vehicle is operational, performs various processes and calculations with the ECM data and relays relevant results and reports to the driver of the vehicle while driving. The output of the automated system pertains to a) the ongoing operational readiness and safety of the vehicle, b) the compliance of the vehicle with laws pertaining to safe vehicle operations and c) the continual evaluation of efficient performance of the vehicle based on data derived from the ECM. The output is provided to the driver in a meaningful context and formats with convenient display and access at all times. The output is a live data stream as opposed to occasional data snapshots, as is the case with prevalent current technology.

Current devices that extract and process ECM data are used to plug-in, diagnose and then unplug after retrieving a summary data file. Current devices run a diagnostic inquiry on an intermittent basis or an occasional inquiry of the ECM. This disclosure pertains to a device that provides instant, always-on, live and unceasing relay of results and reports regarding the immediate condition and performance of a vehicle using the ECM live data feed.

A common function of devices that extract and process ECM data is to determine diagnostic trouble codes (DTCs) that are generated by the sensors reporting status to the ECM inside the engine. The DTC will indicate the cause of a malfunction in the engine, which may be incidental or may be a major impairment of the engine. The device contemplated in this disclosure provides sufficient data as to prevent the occurrence of some DTCs if the vehicle operator takes remedial action at an appropriate time. Not all DTCs are preventable, but for an astute driver, warning signs will be made visible and highlighted if prevention is desired.

### BRIEF DESCRIPTION OF THE DRAWINGS

FIG. 1 is a block diagram of a system configuration in accordance with the disclosure; and

FIG. 2 is an example of system output available to be used by a driver.

### DETAILED DESCRIPTION

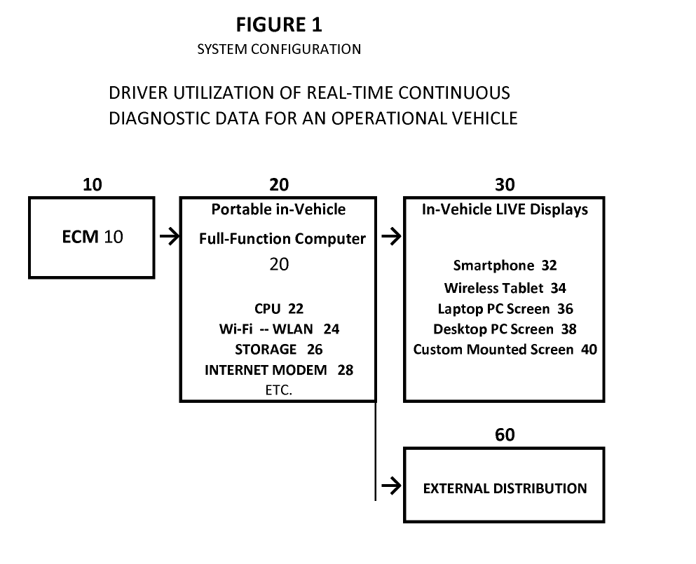

Referring to FIG. 1, a block diagram of a system configuration in accordance with the disclosure, the system generally comprises a connection from the Engine Control Module (ECM) 10, a portable computing device that receives the ECM data 20, an in-vehicle portable display 30, and a transmitter of data to external locations 60. The compact portable computer 20 within the driver compartment is comprised of a processor 22, a wireless local area network (WLAN) via Wi-Fi modem 24, a storage drive for historical data 26, a wireless Internet modem 28, and other standard components of a full-function small-size portable computer. The onboard output displays 30 consist of a smartphone 32, wireless tablet 34, laptop computer screen 36, full-size computer screen 38 and a custom shape and unique configuration screen 40.

The system according to a preferred embodiment of the present disclosure as described in components 20 through 60 of FIG. 1 comprises an automated system and software that resides within the driver compartment of a vehicle. Component 10 of FIG. 1 resides in the engine compartment of a vehicle.

The source of all data utilized by the system contemplated with this disclosure is the Electronic Control Module (ECM) 10 of a human-operated vehicle. The ECM is attached to or inside the engine, and housed in the engine compartment. The ECM continuously collects data from sensors throughout the engine. Different vehicles have varying sensor configurations, but all ECMs monitor all basic functions of a vehicle.

The data from the ECM is sent to the Portable Computer 20 housed in the driver compartment of the vehicle. The portable computer 20 is connected to the ECM 10 by a hard wire cable, which provides both power for the computer as well as transmitting the data. The portable computer 20 is small in size but possesses all the computing power of a standard-sized computer used in many homes and offices.

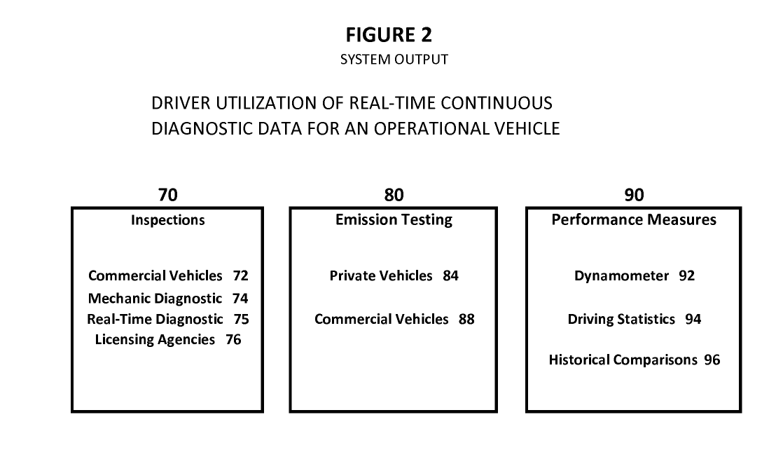

Within the portable computer 20 are all the components of a full-function rich-featured high-speed computer. The central processing unit (CPU) 22 of the computer receives the data from the ECM 10, performs calculations and formatting as prescribed by the custom software applications, and sends the results and reports to any number of display devices 30 via a Wi-Fi modem 24 that facilitates communication to the display which is part of the Wireless Local Area Network (WLAN) in the driver compartment of the vehicle. The CPU 22 performs numerous calculations and computations using the real-time, live, continuous diagnostic data feed from the ECM 10. The processing of data by the CPU 22 generates system output described in FIG. 2 for display on the devices described as part of the live output display 30.

The in-vehicle portable computer 20 also consists of a storage module 26, which is stores data on an hard drive, flash drive or storage card, each or all. The storage device(s) retains historical records of some original data files and also selected output reports and files.

The portable computer 20 also houses an Internet modem 28 on the computer's motherboard. The Internet modem 28 is used to transmit data and records to outside parties 60 not within the driver's compartment of the vehicle. This may include various stakeholders in the operation of the vehicle such as family, employers, customers, friends and other related associates.

The computer 20 sends completed reports and files via the WLAN 24 to one or several in-vehicle output displays 30. One such display device the driver may choose for viewing the live output is a smartphone 32. The data is presented in ways compatible with multi-sized displays, from smartphone size up to full 24-inch computer monitor, although displays as large as 24 inches across would not likely be found in a passenger vehicle for driver viewing.

Another option for output display 30 is a wireless tablet. The size of this device is easy to read, portable and adaptable to the diagnostic reporting formats comprised in this disclosure. The Wi-Fi 24 connection with the computer 20 and the ECM 10 makes the display of output to be virtually instantaneous.

Two options for output display 30 are larger-size screens of laptop and desktop computers. This size screen might be impractical for drivers of passenger vehicles in many cases, but more likely to be found in larger-size vehicles such as trucks.

The final option for output display 30 would be some form of custom viewing device 40 permanently or semi-permanently attached to the dash of the vehicle. The size consideration in this and other devices in various sized vehicles is that the display must not impede vehicle operation nor be a distraction to the driver while the vehicle is operational on the roadway.

The computer 20 also features a storage device 50 to file both input and output data. The storage may be on a hard drive, a flash drive, a data card or other form of data retention. The data would be formatted and filed at the direction of the selected data base software resident on the CPU 22. The purpose of the storage is to provide data for subsequent analysis by the driver if desired.

The final feature of the computer 20 is an Internet modem capability to provide connection to limited external source files if needed and for transmission of data to off-site stakeholders, such as family members, employers, associates, mechanics or other interested parties. This feature allows the diagnostic data collected on a real-time basis which is prepared for the use of the driver while driving to also be distributed to other interested parties authorized by the vehicle operator.

Referring to FIG. 2, a block diagram of the system output in accordance with the disclosure, the system generally comprises a cadre of real-time and snap-shot reports about the operating condition and performance of the vehicle. The output of the system contemplated in this disclosure consists of three general categories of results and reports, namely inspections 70, emissions 80 and efficiency 90. Within the category of inspections 70, there are commercial vehicle inspections 72, mechanic diagnostics 74, driver real-time diagnostic reports and repair work orders 75 and licensing approvals 76. Within the category of emissions 80 there are occasional private vehicle emission tests 84 and real-time commercial vehicle emission tests 88, all based on real-time or stored results while driving. Within the category of efficiency monitoring and improvements 90, included there are driving dynamometer reports 92 which are viewable real-time as well as intermittently stored to report horsepower on the road in varying conditions, loads and road slope. There are also driving statistics 94 based on performance factors such as by-minute fuel burn rate, miles per gallon per ton and other calculated measure of efficiency. There are also comparative statistical reports 96 that analyze current efficiency factors against historical results in any factor of measurement over any period of time.

Inspections 70 are commonly performed to detect existing or potential commercial vehicle malfunction 72 as a safety precaution and also to comply with federal, state or local regulations. Inspections are currently done manually, usually with a checklist of some sort. However, visual inspections 72 cannot assess the internal condition of an engine or other vehicle systems. To enhance commercial vehicle inspections 72 and illuminate critical aspects of engine conditions unseen by external examination, a review and report of the diagnostic data coming from the ECM 10 is necessary. The ECM 10 data cannot replace or eliminate all visual inspection requirements, but the diagnostic information can be utilized in many ways to supplement and expand an inspection to be more comprehensive.

Inspections 70 are most common in repair shops where mechanics perform inspections 74 using a device to analyze the ECM data 10. Almost always the mechanic is using a diagnostic device to examine data indicating a Diagnostic Trouble Code (DTC) has been triggered.

In the system according to a preferred embodiment of the present disclosure as described in FIG. 2 diagram 75, the ECM produces data about the engine beyond the items needing to be repaired, pursuant to the inspection 74. The ECM also produces data about internal engine items such as fluid, filters, fuel and function of key components of the vehicle. At a minimum, all inspections should include a diagnostic report of internal engine conditions 75 and beyond the existing DTCs. A device contemplated by this disclosure would provide a diagnostic report 75 that would include such things as the temperature of oil, coolant, transmission fluid, transaxle, differential and other engine fluids. A diagnostic inspection report 75 might also include pressure readings on brake fluid, fuel pump, water pump, power steering fluid and oil pressure. The absence of DTCs and favorable readings on internally monitored sensors of the engine both provide the most extensive vehicle mechanical inspection possible.

Safety inspections are also required by various states for passenger vehicles 76, and by the US Department of Transportation for commercial motor vehicles (CMVs) 72. The DOT requires an in-depth inspection of a CMV annually.

Inspection of CMVs 72 is required at least daily, and most often prior to every trip of the motor carrier. Paper forms exist in abundance in the industry, and the daily inspections by visual examination are documented with a manual checklist. No check is made on the internal conditions of the engine as part of these inspections. The device contemplated by this disclosure envisions combining the visual inspection certification with the engine diagnostic data into a single automated electronic documented inspection report for CMVs 75. Fluids, filters and function of safety gear can be part of a consolidated inspection report.

Inspection of passenger vehicles 76 is required to renew a vehicle license in many states. Inspection requirements vary by state. In all cases, the diagnostic inspection report 76 can supplement the annual mechanic inspection of the vehicle, and in some case, replace the physical check of engine functionality.

Emission testing and compliance 80 is a major issue with government regulators and enforcement agencies. Many states require passenger vehicles to have emission tests 84 annually, usually in conjunction with the renewal of license plates or tags. The federal Environmental Protection Agency (EPA) also requires commercial vehicles to comply with federal guidelines for emissions 88.

Emission testing for passenger vehicles 84 infrequently generates a repair order or action item to correct the level of emissions. Drivers may not need to examine a vehicle emission level while driving, but it is nonetheless available if they have questions. The data is available from the ECM 10 and processed on the CPU 22 and provided in a report format for the driver to view real-time 84.

The EPA has recently begun to inspect commercial motor vehicle emissions 88 using portable emission tests at roadside inspection locations. The fuel mix in diesel trucks can be altered to generate more power and save fuel, at the expense of dirty emissions. The EPA roadside testing is to catch violators and enforce compliance with federal emission standards in the field. The system contemplated by this disclosure provides a driver with a live, up-to-the-minute reporting of emissions 88. In effect, the truck has a built-in emission testing device continually operating. This feature of the real-time continuous diagnostic device in the driver compartment of motor vehicles may save a driver substantial fines for an emission violation.

The system contemplated by this disclosure provides real-time continuous engine performance data 90 through the portable computer 20 located in the driver's compartment.

All of the analysis and calculations for an engine dynamometer can be derived from the diagnostic data delivered to the portable computer 20 real-time. The computer can generate a dynamometer report on demand, using the continuous data flow from the ECM 10. The computer 20 has external data provided by the driver regarding load weight at any given time. The computer 20 also has GPS data available, including road grade and slope information. The computer 20 will combine the load weight, road grade and various engine measurements, such as RPM and speed, to determine the effective horsepower rating of the engine at any time on demand. The frequent real-time dynamometer reports of effective horsepower 92 are products of the diagnostic data received from the engine sensors through the ECM 10.

A real-time continuous diagnostic data feed can produce as many custom driving performance reports 94 as a vehicle operator can design. Of particular value is the in-vehicle display of live statistics relative to fuel consumption. The computer 20 not only receives the data from the ECM 10 about the fuel level and rate of consumption, but the computer also processes real-time variables such as speed, RPM, acceleration rates, stop rates, turn velocity and other related factors. The immediate fuel burn rate can be calculated and displayed in real-time to enable a driver to see the effect that driving aberrations have on the cost of fuel per minute. With these tools, the custom driving performance reports 94 can provide incentive to drive efficiently.

Historical driving statistics 96 stored on the computer 20 can be retrieved and compare current drivers against previous drivers and conditions. The diagnostic information can be compared with former weeks, months, years or selected periods of time.

Accordingly, improved apparatus, systems and methods for driver utilization of real-time continuous diagnostic data for an operational vehicle has been shown and described.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

1. A device which extracts data from the Engine Control Module of a motor vehicle in real-time, comprising:
an extraction device for obtaining engine information from the engine control module; and
a report generator for generating live, immediate reporting of vehicle operating conditions for a vehicle operator's visual access.

2. The device according to claim 1, wherein said device is connected to the engine computer but located in a driver compartment of the motor vehicle.

3. The device according to claim 1, which is configured as a full-function portable computer and relays real-time, continuous formatted results and calculated reports to the vehicle operator on various in-vehicle visual display screens.

4. The device according to claim 1, which is configured to provide data to the vehicle operator for use in safety, compliance with regulations and efficiency of operation of the vehicle.

5. The device according to claim 1, which is configured to transmit all the real-time continuous formatted results and calculated reports to remote stakeholders via means of an Internet connection.

6. The device according to claim 1, which is configured to store all the real-time continuous formatted results and calculated reports for historical reference and comparison to current data.

7. The device according to claim 1, which is configured as a full-function small-size portable computer and includes a Central Processing Unit (CPU), a Wi-Fi modem to establish a Wireless Local Area Network within the vehicle operator's compartment of the vehicle, an Internet modem for transactions outside the vehicle, and a storage device for historical recording of transactions.

8. A system comprised of a portable in-vehicle computer, connected to an Engine Control Module (ECM), which extracts data from the ECM to generate real-time ongoing data related to operation of the Engine to which the Engine Control Module pertains.

9. The system according to claim 8, wherein said data relates to emission test reports available on demand while driving or stopped to meet federal, state or local regulatory emission inspection requirements.

10. The system according to claim 8, wherein said data relates to engine performance statistics and live displays as well as periodic reports on demand, such as comprising custom fuel efficiency calculations, dynamometer reports and comparisons with historical results and reports.

11. The system according to claim 8, wherein said data provides inspection reports to generate repair and maintenance work orders, and meet inspection criteria for state licensing agencies.
